(19) United States
(12) Patent Application Publication
(10) Pub. No.: US 2003/0121283 A1
(43) Pub. Date: Jul. 3, 2003

(54) Optical glass silica soot particles and method of making same

(76) Inventor: C. Charles Yu, Painted Post, NY (US)

Correspondence Address: CORNING INCORPORATED, SP-TI-3-1, CORNING, NY, 14831

(21) Appl. No.: 10/334,363

(22) Filed: Dec. 31, 2002

Related U.S. Application Data
(62) Division of application No. 09/676,721, filed on Sep. 28, 2000, now abandoned.

(51) Int. Cl. C03B 8/02

(52) U.S. Cl. 65/17.2; 65/17.3

(57) ABSTRACT

The invention relates to optical quality glass made by vacuum casting very stable, low viscosity aqueous suspension of submicron silica particles. The suspension is a mixture of silica particles and aqueous ammonia, and is characterized by a solid loading of up to 75 weight percent.

### FIELD OF THE INVENTION

The invention relates to a process for forming optical quality glass from stable, low viscosity aqueous suspension of submicron silica particles with solid loadings of up to 75 weight percent.

1. Background of the Invention

Silica soot possesses several unique properties that make it a potentially useful raw material for various applications. Silica soot particles used under current invention are a by-product of the high purity fused silica glass making process and until now has been considered a waste material that is typically discarded even though it is essentially pure silicon dioxide. The increasing demand for high purity fused silica for the telecommunications and semiconductor industry to name a few, has led to projections that soot (waste) generation from the production of fused silica, is expected to double in the near future. Not surprisingly, there is a strong desire to reduce this waste stream both from an ecological as well as a financial perspective. At the same time, there is a growing desire to find a productive, commercial application for the waste soot material. This invention relates to a method of making optical glass from silica soot.

2. Summary of the Invention

The invention relates to high purity fused silica made by a process which includes the following steps: mixing water, silica particles (preferably sub-micron spherical particles) and aqueous ammonia to form a preferably low viscosity, aqueous suspension; and vacuum casting the aqueous suspension to form a monolithic green structure of fused silica.

Briefly, the vacuum cast HPFS soot green body has been transformed into optical quality glass by calcining, chemical cleaning (with chlorine containing gas), sintering and finally subjecting the glass to high temperature treatment (above 1700° C.). Due to high green density, there is only about a 12% linear shrinkage after consolidation. The glass has good and stable external transmission above 92%, over 8.1 mm optical path length, from 1315 nm to 4000 nm wavelength, while maintaining about 90% external transmission (equivalent to internal transmission of about 98% per centimeter) at 248 nm. The glass exhibits high transmission in longer wavelength region making such glass particularly suited for various IR applications.

### BRIEF DESCRIPTION OF THE DRAWINGS

FIG. 1 is a TEM micrograph of soot particles from a fused silica production process.

FIG. 2 is a schematic illustration of a system for making silica soot suspension.

FIG. 3 is a schematic illustration of the inventive vacuum casting setup used to make silica glass soot green body.

FIGS. 4 and 5 are SEM analyses of the fracture surface of the inventive vacuum-cast silica glass green body.

FIG. 6 is a picture of a glass piece measuring about 90 mm in diameter and 6 mm in thickness, made by the inventive process.

FIG. 7 is the transmission spectrum of the glass shown in FIG. 6.

### DETAILED DESCRIPTION OF THE INVENTION

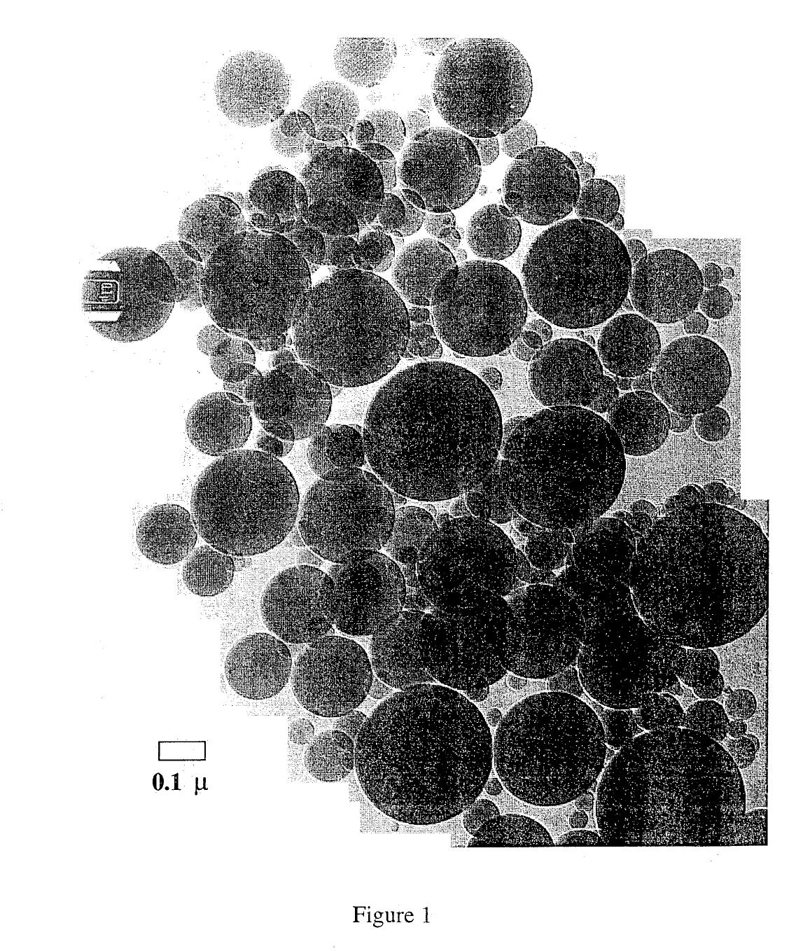

One example of suitable soot particles for the invention include, waste soot particles generated in various fused silica production processes preferably, those generated via a flame hydrolysis process. As more fully described below, flame hydrolysis typically generates high purity, dense, spherical particles of sizes in the 0.05 to 0.4 micron range (average particle size in the 0.2 micron range. FIG. 1 is the TEM micrograph, and Table 1 the chemical analysis of soot particles from a flame hydrolysis process.

TABLE 1

| Ba, Na, Zr | Al, Ca, Co, Ni | Fe, Mg, Ti |
|---|---|---|
| <0.01 wt % | <0.003 wt % | <0.001 wt % |

These characteristics make such silica soot an attractive starting material for various high-tech ceramic productions and possibly other uses. The range of potential applications for soot particles can be greatly increased by purification. In particular, I have found that by purifying the soot particles, optical quality fused silica can be readily produced from the soot collected from the exhaust of a flame hydrolysis furnace. Typically, the soot is collected through a filtration “bag house”. Two contamination sources are introduced by such practice: (1) fall-out fragments from the refractory liner of the furnace; and (2) contaminants in the forms of flying insects. The sizes of the fragments range from several hundred microns to several millimeters, and are vented together with the soot to the bag house. The flying insects are either sucked in through the vents, or attracted by the warm and high humidity environment of the bag house. One specific challenge of the present invention was to device a mechanism for removing these contaminants.

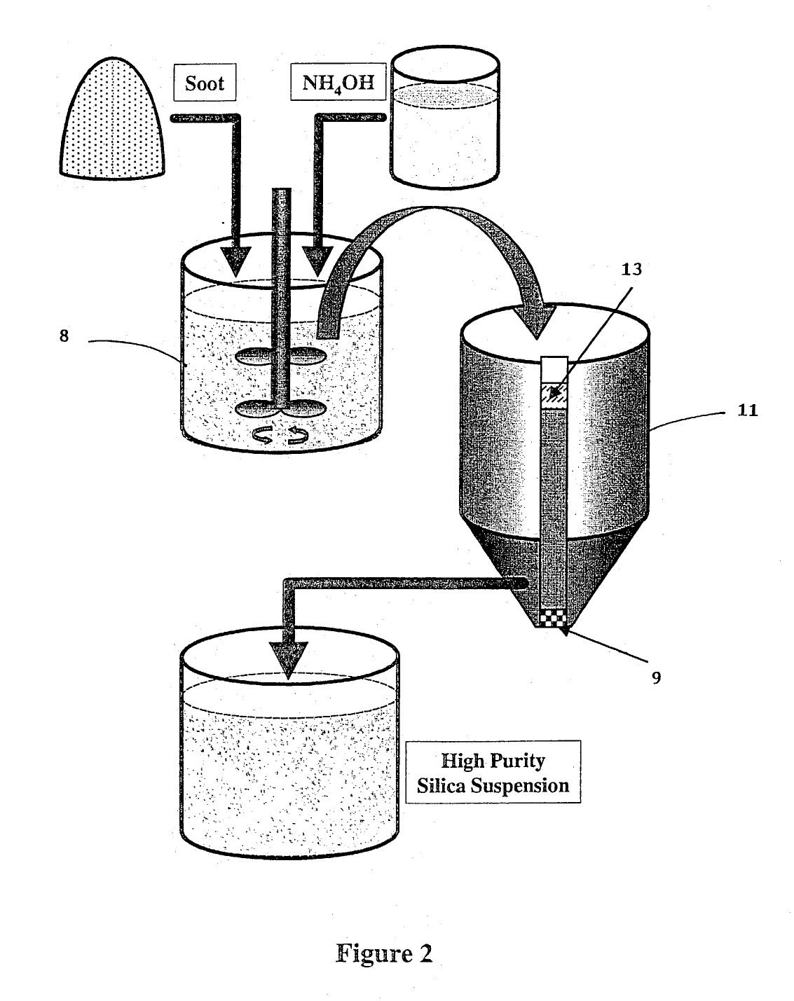

A very stable, low viscosity aqueous suspension of submicron spherical silica particles can be generated by mixing aqueous ammonia solution and silica soot in a mixing tank 8, followed by mechanical agitation. FIG. 2 is a schematic of an illustrative process for producing purified silica soot suspension. The concentration of ammonia solution in the aqueous suspension is preferably at least 0.5 N. Using the system illustrate by FIG. 2, the silica solid loading of the resulting suspension can be as high as 75 wt. %. Large, heavier refractory fragments 9, settle down to the bottom of a purification vessel 11, while the lighter organic contaminants 13, float to the top. Purification is achieved simply by separating and removing the top and bottom fractions of the suspension. By doing this, about 95% or more of the starting silica soot material can be recovered in purified form. The inventive process does not require high shear; thus contamination associated with wear is eliminated by using equipment with plastic liner (e.g., a plastic coated agitator and plastic container). With the purifying action inherent in the process which removes both the heavier refractory fragments and the lighter organic contaminants (insects), the final product maintains the high purity level of the individual soot particles.

Useful soot particles for the present invention are preferably, high purity sub-micron spherical silica particles such as available from the HPFS® production facilities of Corning Incorporated. Unlike other production process, Corning's HPFS® soot is generated by a unique flame hydrolysis or flame combustion process under a specially designed environment. In this process, a high purity silicon containing chemical, such as SiCl₄ or OMCTS, is introduced into an oxygen-hydrocarbon flame to generate silica intermediates in an insulated enclosure, the HPFS laydown furnace. The temperature inside the furnace is maintained at above 1600° C. The silica intermediates include “seeds” of solid silicon dioxide in the nanometer size range, gaseous silicon monoxide, and other intermediate silicon containing compounds (mostly gaseous) from the flame hydrolysis or flame combustion reactions. The silica intermediates experience prolonged residence time under high temperature (≧1600° C.) inside the laydown furnace, during which the solid silicon dioxide “seeds” grow in size and sinter simultaneously into soot particles. A significant amount of the soot particles generated are captured on the “target” and subsequently converted into HPFS® glass as the desired end product. The remaining particles exit from the exhaust and are captured by a bag house as waste. Due to the unique processing approach and the selection of high purity starting chemicals, HPFS® soot consists of high purity, dense, spherical particles of 0.05˜0.4 microns (average size 0.2 micron). See Table 1 and FIG. 1. The present invention resulted from a desire to capture the advantageous characteristics of this high purity, dense, silica soot and to make pure silica optical glass from such soot.

Other potentially useful silica particles suitable for the present invention include, fumed silica produced by flame hydrolysis which consist of high purity, non spherical silica particulate measuring less than 30 nm in size and having extremely high specific surface area. Even though fumed silica is used as catalyst support or as additives, it is rather difficult to form ceramic shape directly from the fumed silica. There are numerous other commercially available sources of fine size (sub-micron) silica particles, such as Cab-O-Sil® (by Cabot Corporation), Aerosil® (by Degussa), and Ludox® (by Du Pont), any of which may be used in the present invention. Ludox consists of aqueous media-dispersed spherical silica particle. The particle size of the silica in Ludox is in nanometer range, and the solid loading is normally below 50 wt %. Ludox is also used mainly as additives, and is very difficult to form directly into ceramic shapes. In addition, Ludox normally contains 0.1˜0.5 wt % Na₂O and a certain amount of undisclosed organic additives as stabilizer. By contrast, the only additive used in the present invention is aqueous ammonia solution, which can be as pure as needed.

I have discovered that silica soot, particularly silica soot collected from a flame hydrolysis process, can form a highly stable, low viscous aqueous suspension of exceptionally high solid loading (up to 75 wt %) without the need for organic/polymer stabilizer. The 75 wt % solid loading is equivalent to about 58 vol % solid loading, a significantly high solid loading for low sub-micron sized particles. Normally, sub-micron ceramic powders require the addition of substantial amounts of organic additives to prevent agglomeration due to their high surface area. Being silicon dioxide, combined with its dense, spherical nature, the HPFS® soot can be effectively dispersed to achieve very high solid loading simply by controlling the surface charge using the pH of the aqueous medium. As shown in FIG. 2, the suspension can be readily made by mixing soot and ammonium hydroxide solution. The simplicity of the system (only three components, soot, water and ammonium hydroxide) makes it feasible to maintain purity during processing; and the high solid loading makes it practical to adapt a casting approach for producing large monolithic green pieces.

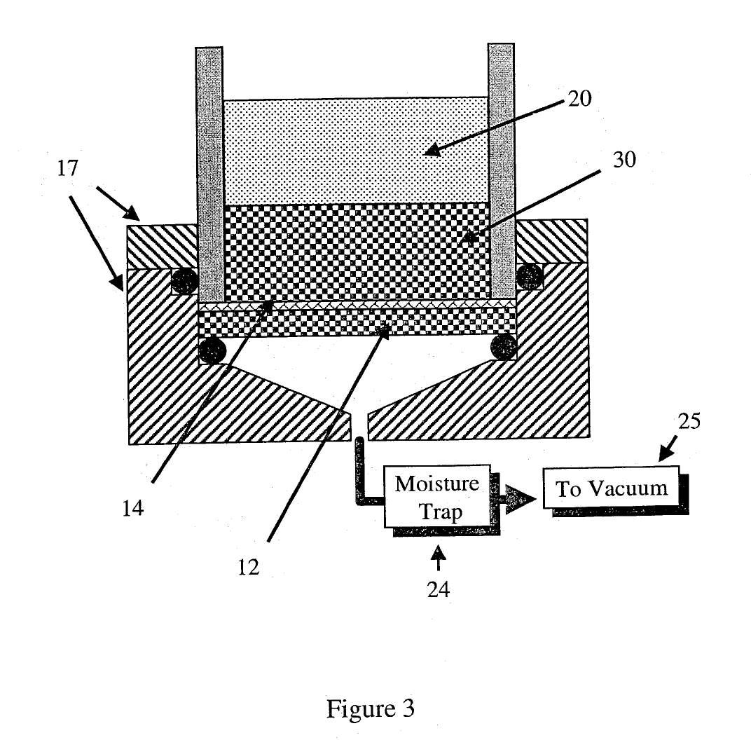

I have developed a vacuum casting method for producing high density silica soot green monolith with uniform microstructure from silica soot suspension. In contrast to conventional cast practice, this inventive vacuum casting method is unique especially in the following two aspects: 1) removal of liquid phase in the suspension via, vapor form; 2) being able to cast suspension consisting of entirely submicron particles. To demonstrate that vacuum casting can be used as described herein, various silica monolithic green bodies measuring 3¾″ (diameter)×2½″ (thickness), were produced by this method. Also, several pieces measuring 6″ (diameter)×1″ (thickness) were produced. The vacuum casting setup is schematically illustrated in FIG. 3. A vessel 10 with a porous support 12 at the bottom is supported by fixture 17, and used as the casting mold 10. A membrane 14 is secured on top of the porous support 12. The high solid loading soot suspension 20 is simply poured into the casting mold 10 with the membrane in place. The bottom part of the mold is then evacuated by connecting to a vacuum source 25 (e.g., a vacuum pump), from the suspension. Preferably, a moisture trap 24 is placed in between the vacuum source 25 and the bottom of the mold 10. The aqueous media in the suspension is removed through vapor phase rather than liquid phase. A solid green monolith (body) 30 is formed as water is being removed from the suspension. The casting process is terminated when the solid body 30 reaches a desired thickness simply by skimming and discarding the soot suspension in the top portion of the mold. After the green body is formed, it is air-dried and removed from the mold and dried at a temperature sufficient to remove any remaining trapped moisture. The body can also be air-dried in the mold, removed and then heat-dried. The heat drying is carried out typically at between 85˜180° C.

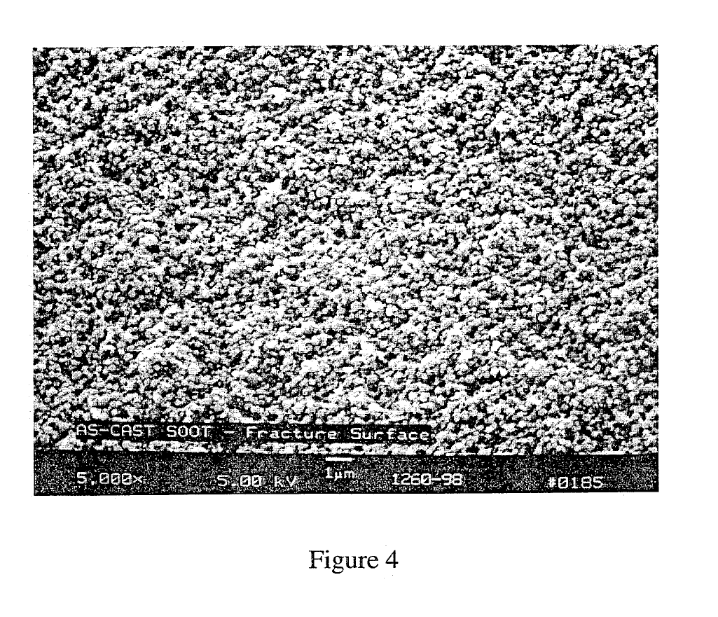

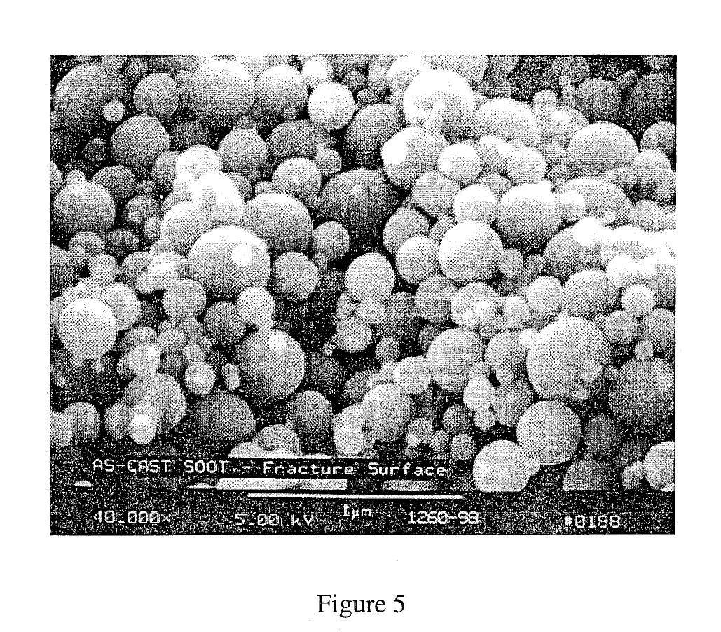

The resulting monolith has a surprisingly high green density of about 70% or more, of the theoretical value. The high homogeneity in the microstructure was evident by visual inspection of the fractured surfaces—no visible voids present. The SEM analyses, FIGS. 4 and 5, of the fracture surface revealed that soot particles were densely packed in the cast body with small ones filling the interstices formed by the big ones. In addition, there is no apparent particle size gradient distribution across the green body.

The dried green bodies were then heated at a rate of 5° C. per minute to 1,000° C., and calcined at that temperature for about 2 to 4 hours. The calcined soot bodies were then treated in an atmosphere of 10% chlorine-90% helium gas mixture, first at 1000° C. to remove excess beta-OH to prevent foaming which may occur, and then treated in an atmosphere of 10% oxygen-90% helium at 1070° C. to reduce the chlorine content of the body. The chlorine and oxygen treatment time depends on the thickness of the green piece because the rate-determining step of chemical reactions were diffusion controlled. Typically for a ¾″ thick piece, the schedule was 8 hours chlorine drying and 2.5 hours of oxygen treatment.

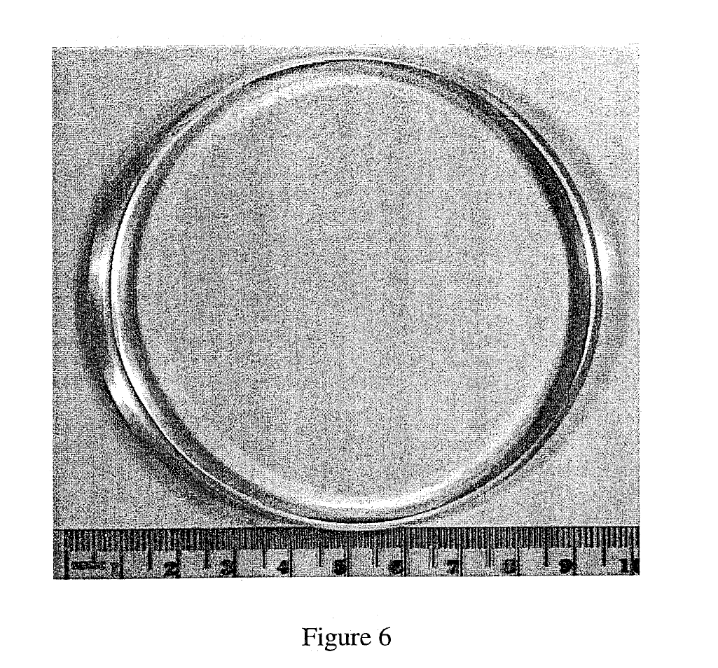

After the chlorine and oxygen treatments, the green body was consolidated, via viscous sintering mechanism, in helium at 1450° C. for about an hour to sinter and fully densify the structure. Prolonged exposure at temperatures above 1000° C., may cause certain degree of devitrification (formation of crystalline material, specifically cristobalite). In this experiment, the appearance of the resulting structures varied from clear, foggy, translucent, to white opaque, depending on the degree of devitrification. To avoid devitrification and obtain optical quality glass, the sintered body was further heated to, and held or “soaked” at a temperature high enough to melt any crystalline material which may have formed during the thermal/chemical treatment and consolidation processes. In the present experiment, the crystalline material was cristobalite. And although the melting point of cristobalite is around 1720° C., higher temperature was required to fully melt the cristobalite due to kinetic reason (the need to overcome the activation energy barrier of the melting process). However, because of the sharp decrease in glass viscosity, and therefore, the high deformation tendency at temperature above 1730° C., the preferable final temperature of 1760° C. was chosen to balance kinetics and deformation. The final heat treatment was conducted under a vacuum environment. The sintered soot body was typically heated at a rate of 25° C. per minute to 1760° C., and then “soaked” at this temperature for 30 minutes. FIG. 6 is a picture of a glass piece measuring about 90 mm in diameter and 6 mm in thickness, made by the process described above. The beta-OH concentration of the glass was below detection level (<1 ppm), making the glass particularly useful for certain applications requiring IR transmission.

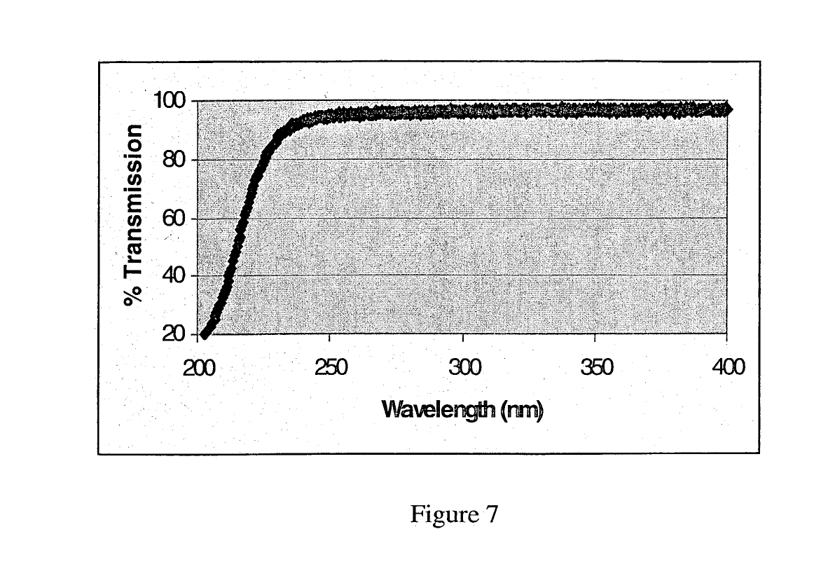

FIG. 7 is the transmission spectrum, with 8.13 mm optical path length, of the glass of FIG. 6. As shown, the glass exhibited relatively good and stable transmission of about 95% level from 400 nm down to about 250 nm, as well as a rather sharp transmission drop-off in the UV region. Between 250 nm and 235 nm, the transmission dropped from 95% to 90%; and from 235 nm to 220 nm, the transmission dropped at an even faster rate, from 90% to around 65%. At close to about 200nm, the transmission dropped below 20%.

At 248 nm, the external transmission dropped to 89.92%, which corresponds to an internal transmission of 97.98% per centimeter. Below 248 nm, the external transmission dropped at a faster rate to 17.10% at 193 nm and only 9.45% at 185 nm.

Table 2 is the ICP trace metal element analysis of the soot glass of FIG. 6. As shown, the glass contained ppm levels of alkaline metal elements (0.6 ppm K, 0.4 ppm Na) and sub-ppm levels of iron (0.2 pp, Fe), which were likely responsible for the UV transmission cut-off below 250 nm.

To further reduce the level of contaminants in the glass, a soot pre-cleaning step may be incorporated into the inventive process. Examples of useful purification methods which may be adapted to the present invention include: room temperature acid wash; or a high temperature (900˜1100° C.) chlorine or fluorine treatment, for example. These purification steps which may be carried out prior to the vacuum casting step, will decrease the level of contamination substantially, and push the UV transmission edge to an even shorter wavelength.

TABLE 2

| Element | Al | Ca | Fe | K | Li | Na | Ti | Zn | Zr |
|---|---|---|---|---|---|---|---|---|---|
| Concentration | 7.5 | <0.02 | 0.2 | 0.6 | <0.02 | 0.4 | 1.2 | <0.02 | 2.0 |

Although I have disclosed the now preferred embodiments of the invention, it will be apparent to those skilled in the art that various changes and modifications may be made thereto without departing from the spirit and scope thereof as further defined in the appended claims.

1. High purity fused silica made by a process comprising:
a) mixing water, silica particles and aqueous ammonia to form an aqueous suspension; and
b) vacuum casting the aqueous suspension to form a monolithic green body of fused silica.

2. Fused silica according to claim 1, further comprising the step of separating out, and removing any organic contaminants from the suspension prior to the vacuum casting step.

3. Fused silica according to claim 1, wherein solid phase in the aqueous suspension comprises entirely of submicron particles.

4. Fused silica according to claim 1, wherein liquid phase in the aqueous suspension comprises ammonium hydroxide solution.

5. Fused silica according claim 1, made by a process further comprising the step of heat-treating the green body to remove any trapped moisture.

6. Fused silica according to claim 5, made by a process further comprising the step of calcining the green body.

7. Fused silica according to claim 6, made by a process further comprising the step of heat-treating the green body in a chlorine/helium atmosphere to remove any excess beta hydroxyl groups.

8. Fused silica according to claim 7, made by a process further comprising the step of heat-treating the green body in a chlorine/helium atmosphere to reduce the chlorine content.

9. Fused silica according to any one of claims 1-8, made by a process further comprising the step of consolidating the green body to form a non-porous fused silica structure.

10. Method of forming an optical quality fused silica body by:
a) heating the non-porous structure of claim 9 to a temperature sufficiently high to melt any crystalline phases contained in the structure; and
b) holding the structure at said temperature for a duration sufficient to complete the melting of said crystalline phases.

11. Method according to claim 10 wherein prior to the vacuum casting step, the aqueous suspension is further subjected to a purification step selected from the group consisting of, room temperature acid wash, and high temperature halogen treatment.

12. Silica soot suspension comprising submicron spherical particles of silica and aqueous ammonia.

13. Silica suspension according to claim 12 wherein solid loading of silica is up to 75 weight percent.

14. Silica suspension according to claim 13 wherein the silica particles comprise high purity, dense spherical particles measuring 0.05 to 0.4 microns in diameter.

15. Silica suspension according to claim 14 wherein the particles have an average size of about 0.2 microns.
